(19) United States
(12) Patent Application Publication
(10) Pub. No.: US 2019/0357656 A1
(43) Pub. Date: Nov. 28, 2019

(54) RECEPTACLE FOR MIXING OF DIFFERENT MATERIALS

(71) Applicant: Seong Il KANG, Seongnam-si, Gyeonggi-do (KR)

(72) Inventor: Seong Il KANG, Seongnam-si, Gyeonggi-do (KR)

(21) Appl. No.: 16/478,026

(22) PCT Filed: Jan. 11, 2018
(86) PCT No.: PCT/KR2018/000550

§ 371 Date: Jul. 15, 2019

(30) Foreign Application Priority Data
Jan. 18, 2017 (KR) 10-2017-0008698

(51) Int. Cl. A45D 33/26; A45D 33/02; A45D 34/04; B65D 81/32; B05B 11/00

(52) U.S. Cl. CPC A45D 33/26; A45D 33/02; A45D 34/04; A45D 2200/058; B05B 11/3084; B05B 11/0038; A45D 2200/054; B65D 81/3227

(57) ABSTRACT

Provided is a receptacle for mixing different materials, including: an outer receptacle for accommodating cosmetic contents; an inner receptacle of a cylindrical member, which is inserted to an inner circumference of an upper opening portion of the outer receptacle and has an upper surface flange placed over the upper surface of the upper opening portion; a shoulder member of a cylindrical member, of which the upper and lower parts are opened and the lower part is screw-coupled to the upper opening portion of the outer receptacle, and the middle part pushes to fix the upper flange of the inner receptacle and at the same time to fix the first and the second pump set; a push button which is fixed on the upper side of the first and the second pump set; and a cover member of a cylindrical member.

### TECHNICAL FIELD

The present invention relates to a receptacle for mixing different materials, and more particularly, to a receptacle for mixing different materials, in which an inner receptacle is inserted into an outer receptacle, each of pump sets is mounted in the inner receptacle, and thereby it is possible to store cosmetic contents different from each other in the inner receptacle and the outer receptacle, and use them simultaneously by one pumping.

### BACKGROUND ART

When two materials of different ingredients (cosmetics, etc.) are mixed in advance, a problem that these materials are deteriorated due to chemical reaction in the mixed state or the performance is remarkably deteriorated may occur. When two containers are prepared, stored separately and then mixed to use by the user, a problem of causing inconvenience in use is caused.

In order to solve these problems, a receptacle of mixing different materials having a structure capable of mixing two materials by the operation of the user after separating and storing two materials in one receptacle is used.

FIGS. 6 and 7 are cross-sectional views of a conventional container of mixing different materials.

The conventional container for mixing different materials, as shown in these drawings, includes: a container body portion 111, in which a container storage space 111a is formed and a container opening 111b is formed at an upper end thereof; s shoulder portion 113 coupled to an upper end of the container body portion 111; an inner cap 112 formed integrally with the shoulder portion 113; a container cap 118 coupled to the shoulder portion 113; a push button 114 disposed on the upper side of the inner cap 112; a pressure tube 119 coupled to the bottom surface of the push button 114; a cylinder 150 installed to communicate with the container storage space 111a; a pumping portion 140 interposed between the cylinder 150 and the push button 114; and a secondary storage space portion 160 provided with a secondary storage space body portion 161 coupled to the cylinder 150.

The inner cap 112 is formed with a cap hole 112a in a central region thereof.

The inner cap 112 having such a configuration is coupled to the shoulder portion 113 so that the cap hole 112a communicates with the container storage space 11a.

The push button 114 is formed with a “¬”—shaped button flow path 114a which connects the bottom surface and the side surface. The push button 114 can move along the height direction of the container body portion 111.

The pressure tube 119 is formed so as to communicate with the button flow path 114a and the cap hole 112a.

The cylinder 150 is provided with a narrowed portion 151 in a bottom region thereof.

The narrowed portion 151 is formed with a through hole 151a in the bottom surface thereof and a cylinder engaging tap 151b formed on the inner surface thereof.

The pumping portion 140 includes: a ring-shaped pumping piston 141 installed in the cylinder 150; an operating shaft 145 installed to enter into the pressure tube 119 through the pumping piston 141; an operation rod 146 installed in the operating shaft 145; an opening and closing recessed portion 147 formed at the lower end of the operation rod 146; a straw support tube 148 installed so that the upper end thereof reaches the bottom surface of the opening and closing recessed groove portion 147 and the lower end thereof goes through the through hole 151a to be exposed to the outside of the cylinder 150; a straw 149 installed inside the straw support tube 148; and a return spring 144 installed to support both ends thereof in the push button 114 and the inner cap 112.

The pumping piston 141 is in close contact with the inner surface of the cylinder 150 such that an intermediate storage chamber 150a is formed between the bottom surfaces of the cylinder 150.

The pumping piston 141 is installed in the cylinder 150 to be spaced apart from the lower end of the pressure tube 119.

Accordingly, when lowering the pressure tube 119 by pressurizing the press button 114, the pumping piston 141 is lowered alone by the distance that the pressure tube 119 is spaced apart from the pumping piston 141, and then can be lowered together with the pressure tube 119.

The operating shaft 145 includes a linear operating shaft body portion 145b and a stem 145c formed at the lower end of the operating shaft body portion 145b.

The inner space of the operating shaft body portion 145b becomes the operating shaft flow path 145a.

The stem 145c presses the pumping piston 141 upward in a lifting operation.

The operating shaft 145 having such a configuration is installed such that the stem 145c passes through the pumping piston 141 and the operating shaft body portion 145b is coupled to the pressure tube 119. Accordingly, the operating shaft 145 can be moved up and down together with the pressure tube 119.

The opening and closing recessed groove portion 147 is provided with a plurality of opening and closing recessed groove flow path forming protrusions 147a formed on the upper side of the outer surface thereof so as to protrude along the longitudinal direction.

The opening and closing recessed groove flow path forming protrusions 147a are spaced apart from each other, and thus the opening and closing recessed groove flow path is formed in a space between the opening and closing recessed groove flow path forming protrusions 147a.

The straw support tube 148 is formed with a plurality of support tube flow path forming protrusions 148a protruding at the upper side of the outer surface thereof along the longitudinal direction thereof.

The support tube flow path forming protrusions 148a are spaced apart from each other, and thus a support tube flow path is formed in a space between the support tube flow path forming protrusions 148a. The return spring 144 is installed so that both ends are supported by the push button 114 and the inner cap 112.

The auxiliary storage space portion 160 is provided with an auxiliary storage space sealing plate portion 162 formed at the lower end of the straw support tube 148 in addition to the auxiliary storage space body portion 161.

The auxiliary storage space sealing plate portion 162 is formed so as to be disposed perpendicularly to the longitudinal direction of the straw support tube 148.

The auxiliary storage space body portion 161 has a configuration capable of forming a closed space in cooperation with the straw supporting tube 148, the auxiliary storage space sealing plate portion 162, and the cylinder 150.

The operation of conventional receptacle for mixing different materials having such a configuration will be described herein with reference to FIGS. 7 and 8. For convenience of explanation, it is assumed that the liquid cosmetics are stored in the inner space of the container body portion 111, that is, the container storage space 111a, and the powdered cosmetics are stored in the auxiliary storage space portion 160.

When the push button 114 is first pressed downward, the pressure tube 119 is lowered alone by a distance spaced apart from the pumping piston 141, and then the pressure tube 119 is lowered together with the pumping piston 141. When the push button 114 is pressed, an elastic force is accumulated in the return spring 144.

When the pressure tube 119 is lowered, the opening and closing recessed groove portion 147 and the straw support tube 148 also lowered. Here, the lowering of the opening and closing recessed groove portion 147 is made such that the opening and closing recessed groove flow path forming protrusions 147a crosses the cylinder engaging tap 151b.

When the straw support tube 148 is lowered, the auxiliary storage space sealing plate portion 162 is also lowered so as to cross the lower end of the auxiliary storage space body portion 161.

When the auxiliary storage space sealing plate portion 162 is lowered, the powder cosmetics stored in the auxiliary storage space portion 160 and the liquid cosmetics stored in the container storage space 111a are mixed (see FIG. 7).

Next, when the pressing force to the push button 114 is released, the push button 114 is lifted to the original position by the elastic force accumulated in the return spring 144. When the push button 114 is lifted, the operating shaft 145 and the pumping piston 141 are raised and the operating shaft flow path 145a is closed by the pumping piston 141.

When the operating shaft 145 is raised, the operating rod 146 and the opening and closing recessed groove portion 147 are also lifted. Here, the rising distance between the operating rod 146 and the opening and closing recessed groove portion 147 is limited by the engagement action between the opening and closing recessed groove flow path forming portion 147a and the cylinder engaging tap 151b.

When the operating rod 146 and the opening and closing recessed groove portion 147 are lifted, the groove bottom surface of the opening and closing recessed groove portion 147 and the upper end of the straw 149 are spaced apart from each other, and accordingly the container storage space 111a is connected to the intermediate storage chamber 150a through the opening and closing recessed groove flow path, which is formed in a space between the straw 149 and the opening and closing recessed groove flow path forming protrusion portions 147a, and the support tube flow path, which is formed in a space between the support tube flow path forming protrusions 148a.

In this way, when the container storage space 111a is connected to the intermediate storage chamber 150a, the operating shaft 145 is raised to generate a negative pressure in the intermediate storage chamber 150a, and the mixed cosmetics in the container storage space 111a flow into the intermediate storage chamber 150a through the support tube flow path (see FIG. 8).

Next, when the push button 114 is pressed downward, the pressure tube 119 is lowered alone by a distance spaced apart from the pumping piston 141, and then the pressure tube 119 is lowered together with the pumping piston 141.

The operating shaft flow path 145a communicates with the intermediate storage chamber 150a while the pressure tube 119 is lowered alone by the distance spaced apart from the pumping piston 141.

When the operating shaft flow path 145a communicates with the intermediate storage chamber 150a, the mixed cosmetics in the intermediate storage chamber 150a sequentially pass through the operating shaft flow path 145a, the pressure tube 119, and the button flow path 114a to be discharged to the outside.

On the other hand, when the push button 114 is lowered, elastic force is accumulated in the return spring 144.

Next, when the pressing force to the push button 114 is released, the push button 114 is raised to the original position by the elastic force accumulated in the return spring 144.

When the push button 114 is raised, the operating shaft 145 and the pumping piston 141 are lifted, and the operating shaft flow path 145a is closed by the pumping piston 141.

When the operating shaft 145 is lifted, a negative pressure is generated in the intermediate storage chamber 150a, and the mixed cosmetics in the container storage space 111a flow into the intermediate storage chamber 150a.

A conventional receptacle for mixing different materials having the above-described configuration is disclosed in a Utility Model Application No. 2002-0015583 (Title of Utility Model: MIXED COSMETIC CONTAINER).

However, according to the conventional container for mixing different materials, since different materials are mixed by a method of lowering the auxiliary storage space sealing plate portion 162 though the operating rod 146, the opening and closing recessed groove portion 147, and the straw support tube 148, which are installed in the cylinder 150, there has been a problem in that the configuration for mixing different materials is complicated and the product is difficult to assemble.

Since the operating rod 146, the opening and closing recessed groove portion 147, and the straw support tube 148 are disposed in the cylinder 150, there has been a problem in that the size of the intermediate storage chamber 150a is reduced due to the configuration of mixing different materials.

### DISCLOSURE

### Technical Problem

The present invention is invented to meet the needs of the above conventional technology, and it is an object of the present invention to provide a receptacle for mixing different materials, in which an inner receptacle is inserted into an outer receptacle, each of pump sets is mounted in the inner receptacle, and thereby it is possible to store cosmetic contents different from each other in the inner receptacle and the outer receptacle and use them simultaneously by one pumping.

### Technical Solution

A receptacle for mixing different materials according to a first embodiment of the present invention, includes: an outer receptacle 10 for accommodating cosmetic contents; an inner receptacle 20 of a cylindrical member, which is inserted to an inner circumference of an upper opening portion 11 of the outer receptacle and has an upper surface flange 23 placed over the upper surface of the upper opening portion 11, wherein a space is divided so that a first and a second pump sets 30, 40 can be inserted therein; a shoulder member 50 of a cylindrical member, of which the upper and lower parts are opened, the lower part is screw-coupled to the upper opening portion 11 of the outer receptacle 10, and the middle part pushes to fix the upper flange 23 of the inner receptacle 20 and at the same time to fix the first and the second pump set 30, 40; a push button 60 which is fixed on the upper side of the first and the second pump set 30, 40 and presses the first and the second pump set 30, 40 to discharge cosmetic contents liquid to the outside; and a cover member 70 of a cylindrical member, only the lower part covering the push button 60 of which is opened, which is coupled to a circumferential protrusion 51 formed on the upper outer circumference of the shoulder member 50.

The inner receptacle 20 is divided into: a center space portion 21, which passes through the center toward the upper and the lower parts for inserting the first pump set 30 and discharging cosmetic contents in the outer container 10; and an outer circumferential mounting space portion 22, which is an outer circumferential space of the center space portion 21, into the opened upper part of which the second pump set 40 is inserted, and the lower part thereof is closed to discharge the cosmetic contents contained therein through the second pump set 40.

The outer circumferential mounting space portion 22, the lower part of which is tapered so that the cosmetic contents therein are gathered in one place.

### Advantageous Effects

According to a receptacle for mixing different materials of the present invention, it is configured to mount an inner receptacle 20 on the inner circumference of the upper opening portion 11 of the outer receptacle 10, wherein the inner receptacle is divided into a center space portion 21, which passes through the center toward the upper and the lower parts for inserting the first pump set 30 and discharging cosmetic contents into the outer container 10; and an outer circumferential mounting space portion 22, which is an outer circumferential space of the center space portion 21, into the opened upper part of which the second pump set 40 is inserted, and the lower part thereof is closed to discharge the cosmetic contents contained therein through the second pump set 40, and thereby it is possible to store cosmetic contents different from each other in the outer receptacle 10 and the inner receptacle 20 and use them simultaneously by one pumping.

### DESCRIPTION OF DRAWINGS

FIG. 1 is a cross-sectional view showing a receptacle for mixing different materials according to a first embodiment of the present invention.

FIG. 2 is a cross-sectional view taken along the line A-A in FIG. 1.

FIG. 3 is a perspective view showing an inner receptacle of the receptacle for mixing different materials according to the first embodiment of the present invention.

FIG. 4 is a side view showing the inner receptacle of the receptacle for mixing different materials according to the first embodiment of the present invention.

FIG. 5 is a side view showing the inner receptacle in another form according to the first embodiment of the present invention.

FIGS. 6 and 7 are cross-sectional views of a conventional receptacle for mixing different materials.

FIGS. 8 and 9 are diagrams showing a method of using a conventional receptacle for mixing different materials, respectively.

### BEST MODE

Hereinafter, preferred embodiments of the present invention will be described in detail with reference to the accompanying drawings so that these can easily be carried out by those skilled in the art. It should be noted that reference numerals shown in the attached drawings are used throughout the different drawings to denote the same components whenever possible. In addition, in describing the present invention, the detailed description of known functions or known configurations incorporated herein will be omitted if it is deemed that it may unnecessarily obscure the gist of the present invention. Some features shown in the drawings are magnified, reduced, or simplified for ease of explanation, and the drawings and their components are not necessarily illustrated at an appropriate rate. However, those skilled in the art will easily understand these details.

It will be understood that the terms including ordinals such as “first,” “second,” etc. may be used herein to describe various components, but these components are not limited to the terms. These terms are used only to distinguish one component from another component. For example, the first component may be referred to as a second component without departing from the scope of the claims of the present invention, and similarly, the second component may also be referred to as a first component. The term “and/or” includes any combination of a plurality of related listed items or any of a plurality of related listed items.

In addition, related terms described on the basis of what is shown in the drawings such as “front,” “rear,” “top,” “below,” and the like may be replaced with ordinals such as “first,” “second,” and the like.

The ordinal numbers such as “first,” “second,” and the like are arbitrarily set in the order described, and thus the order may be arbitrarily changed as necessary.

The terminology used herein is for the purpose of describing particular embodiments only and is not intended to be limiting of the invention. The singular forms comprise plural referents unless the context clearly dictates otherwise. It is to be understood that the terms such as “comprise” or “have” as described in the present specification, are intended to designate the presence of stated features, numbers, steps, operations, components, parts or combinations thereof, but not to preclude the possibility of the presence or addition of one or more other features, numbers, steps, operations, components, parts, or combinations thereof.

Unless otherwise defined, all terms including technical and scientific terms used herein have the same meaning as commonly understood by those skilled in the art to which the present invention pertains. The terms defined in commonly used dictionaries should be interpreted as having a meaning that is consistent with their meaning in the context of the relevant arts, and will not be interpreted in an idealized or overly formal meaning unless expressly so defined herein.

Hereinafter, preferred embodiments of the present invention will be described in detail with reference to the accompanying drawings. In addition, in describing the present invention, the detailed description of known configurations or functions incorporated herein will be omitted if it is deemed that it may unnecessarily obscure the gist of the present invention.

### First Embodiment

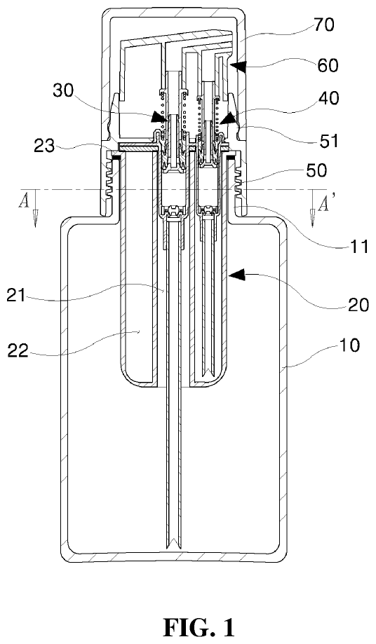

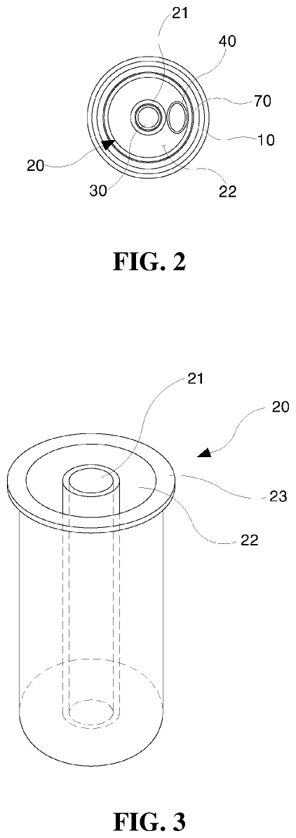

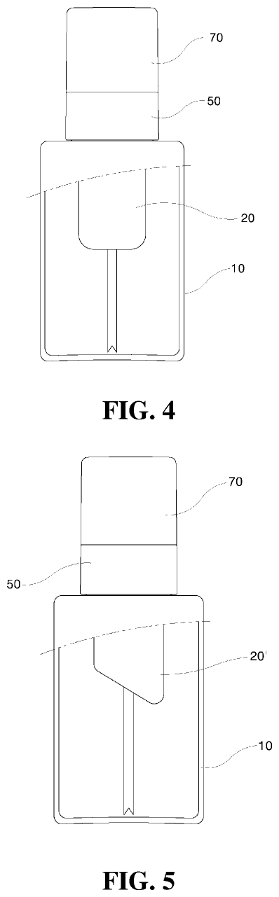

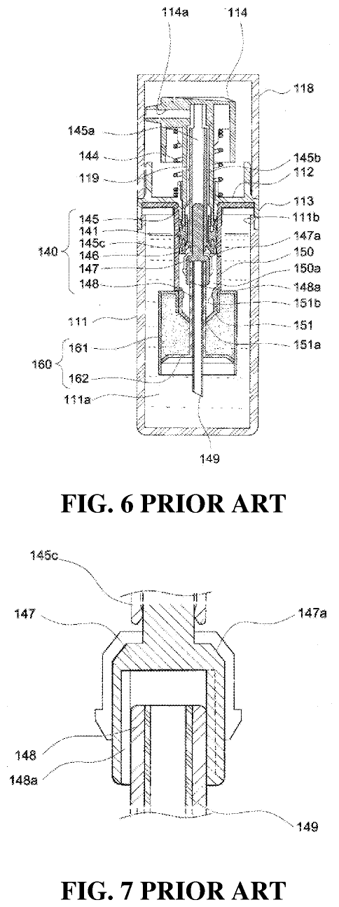

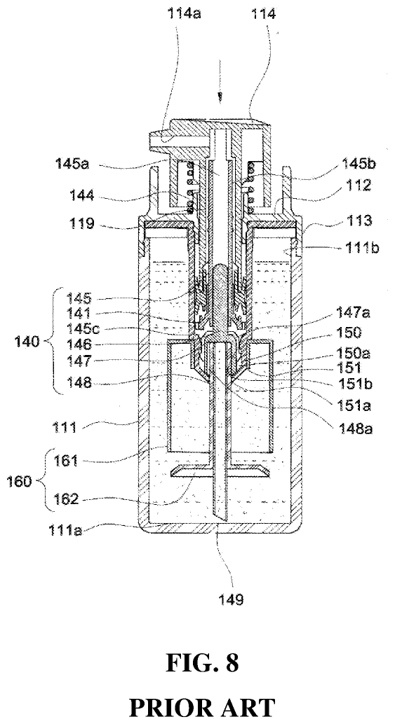

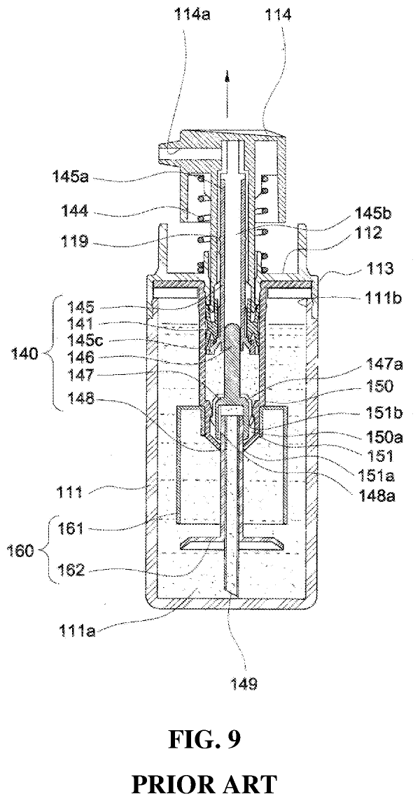

FIG. 1 is a cross-sectional view showing a receptacle for mixing different materials according to a first embodiment of the present invention; FIG. 2 is a cross-sectional view taken along the line A-A in FIG. 1; FIG. 3 is a perspective view showing an inner receptacle of the receptacle for mixing different materials according to the first embodiment of the present invention; FIG. 4 is a side view showing the inner receptacle of the receptacle for mixing different materials according to the first embodiment of the present invention; and FIG. 5 is a side view showing the inner receptacle in another form according to the first embodiment of the present invention.

As shown in the above-described drawings, the receptacle for mixing different materials according to a first embodiment of the present invention includes: an outer receptacle 10 for accommodating cosmetic contents; an inner receptacle 20 of a cylindrical member, which is inserted to an inner circumference of an upper opening portion 11 of the outer receptacle and has an upper surface flange 23 placed over the upper surface of the upper opening portion 11, wherein a space is divided so that a first and a second pump sets 30, 40 can be inserted therein; a shoulder member 50 of a cylindrical member, of which the upper and lower parts are opened and the lower part is screw-coupled to the upper opening portion 11 of the outer receptacle 10, and the middle part pushes to fix the upper flange 23 of the inner receptacle 20 and at the same time to fix the first and the second pump set 30, 40; a push button 60 which is fixed on the upper side of the first and the second pump set 30, 40 and presses the first and the second pump set 30, 40 to discharge cosmetic contents liquid to the outside; and a cover member 70 of a cylindrical member, only the lower part covering the push button 60 of which is opened, which is coupled to a circumferential protrusion 51 formed on the upper outer circumference of the shoulder member 50.

The inner receptacle 20 is divided into: a center space portion 21, which passes through the center toward the upper and the lower parts for inserting the first pump set 30 and discharging cosmetic contents in the outer container 10; and an outer circumferential mounting space portion 22, which is an outer circumferential space of the center space portion 21, into the opened upper part of which the second pump set 40 is inserted, and the lower part thereof is closed to discharge the cosmetic contents contained therein through the second pump set 40.

The inner receptacle 20 as shown in FIG. 5 is a receptacle, the lower part of which is tapered so that the cosmetic contents therein are gathered in one place.

The first and the second pump sets 30, 40 have one selected from cross-sectional shapes in the shape of a circle and an ellipse.

Here, the present invention is describing that the first pump set 30 has a circular cross-sectional shape, and the second pump set 40 has an elliptical cross-sectional shape.

The receptacle for mixing different materials according to the first embodiment of the present invention as described above is configured to mount an inner receptacle 20 on the inner circumference of the upper opening portion 11 of the outer receptacle 10, wherein the inner receptacle is divided into a center space portion 21, which passes through the center toward the upper and the lower parts for inserting the first pump set 30 and discharging cosmetic contents into the outer container 10; and an outer circumferential mounting space portion 22, which is an outer circumferential space of the center space portion 21, into the opened upper part 11 of which the second pump set 40 is inserted, and the lower part thereof is closed to discharge the cosmetic contents contained therein through the second pump set 40, and thereby it is possible to store cosmetic contents different from each other in the outer receptacle 10 and the inner receptacle 20 and use them simultaneously by one pumping.

As described above, while the present invention has been described with respect to the specific embodiments, it will be apparent to those skilled in the art that various changes and modifications may be made without departing from the spirit and scope of the present invention as defined in the claims.

1. A receptacle for mixing different materials, comprising:
an outer receptacle (10) for accommodating cosmetic contents;
an inner receptacle (20) of a cylindrical member, which is inserted to an inner circumference of an upper opening portion (11) of the outer receptacle and has an upper surface flange (23) placed over the upper surface of the upper opening portion (11), wherein a space is divided so that a first and a second pump sets (30, 40) can be inserted therein;
a shoulder member (50) of a cylindrical member, of which the upper and lower parts are opened and the lower part is screw-coupled to the upper opening portion (11) of the outer receptacle (10), and the middle part pushes to fix the upper flange (23) of the inner receptacle (20) and at the same time to fix the first and the second pump set (30, 40);
a push button (60) which is fixed on the upper side of the first and the second pump set (30, 40) and presses the first and the second pump set (30, 40) to discharge cosmetic contents liquid to the outside; and
a cover member (70) of a cylindrical member, only the lower part covering the push button (60) of which is opened, which is coupled to a circumferential protrusion (51) formed on the upper outer circumference of the shoulder member (50).

2. The receptacle for mixing different materials according to claim 1, wherein the inner receptacle is divided into:
a center space part (21) which passes through the center toward the upper and the lower parts for inserting the first pump set (30) and discharging cosmetic contents in the outer container (10); and
an outer circumferential mounting space portion (22), which is an outer circumferential space of the center space portion 21, into the opened upper part of which the second pump set 40 is inserted, and the lower part thereof is closed to discharge the cosmetic contents contained therein through the second pump set (40).

3. The receptacle for mixing different materials according to claim 2, wherein the outer circumferential mounting space portion (22), the lower part of which is tapered so that the cosmetic contents therein are gathered in one place

4. The receptacle for mixing different materials according to claim 2, wherein the first and the second pump sets (30, 40) have one selected from cross-sectional shapes in the shape of a circle and an ellipse.
